(19) United States
(12) Patent Application Publication
(10) Pub. No.: US 2022/0337939 A1
(43) Pub. Date: Oct. 20, 2022

(54) ACOUSTIC DEVICE AND ELECTRONIC APPARATUS

(71) Applicant: GOERTEK INC., Weifang, Shandong (CN)

(72) Inventors: Chunfa LIU, Weifang, Shandong (CN); Tongyan XU, Weifang, Shandong (CN); Chengfei ZHANG, Weifang, Shandong (CN)

(21) Appl. No.: 17/416,708

(22) PCT Filed: Dec. 19, 2019
(86) PCT No.: PCT/CN2019/126459

§ 371 Date: Dec. 6, 2021

(30) Foreign Application Priority Data
Dec. 19, 2018 (CN) 201811560108.0

(51) Int. Cl. H04R 1/28; H04R 1/02; H04R 7/12

(52) U.S. Cl. CPC H04R 1/288; H04R 1/025; H04R 7/12; H04R 1/2834

(57) ABSTRACT

An acoustic device comprises a sound generating unit comprising a diaphragm. An acoustic wave at a front side radiates outwards through a sound outlet. A closed cavity is formed at a rear side of the vibrating diaphragm. Volume adjustment regions are provided in the closed cavity, the volume adjustment regions are a sound absorption portion, a porous sound absorbing material is provided on the sound absorption portion, and the volume adjustment regions are a flexibly deformable portion. The closed cavity is divided into first and second closed cavities by a partition. The first closed cavity is adjacent to the diaphragm, the second closed cavity is far away from the vibrating diaphragm. The flexibly deformable portion is at least part of the partition, and deforms flexibly. The sound absorbing material is provided in the first and/or the second closed cavity, and effectively increase the equivalent volume of the closed cavity.

### TECHNICAL FIELD

The present disclosure relates to the technical field of acoustics, in particular, relates to an acoustic device and an electronic apparatus in which the acoustic device is mounted.

### BACKGROUND ART

Generally, an acoustic system with a traditional structure (Prior Art 1) includes a closed housing and a sound generating unit provided on the closed housing, a cavity is formed between the closed housing and the sound generating unit. As the volume of the cavity in the acoustic system is limited, the acoustic system, especially a small acoustic system, is difficult to achieve a satisfactory effect for reproducing low pitch. Conventionally, in order to satisfactory achieve a satisfactory effect for reproducing low pitch in the acoustic system, two ways are usually used. One way is to provide a sound absorbing material (such as activated carbon, zeolite, etc.) in the housing of the acoustic system to adsorb or desorb the gas within the housing, for achieving the effect of increasing the volume and therefore reducing the low-frequency resonance frequency. The other way is to mount a passive radiator on the housing of the acoustic system (Prior Art 2), as shown in FIG. 1, wherein, a reference numeral 10 refers to a sound generating unit, a reference numeral 20 refers to the housing of the acoustic system, a reference numeral 30 refers to the passive radiator. The sound generating unit and the passive radiator radiate the sound to outside simultaneously, and the acoustic waves of the sound generating unit and the passive radiator are communicated and superimposed to enhance the local sensitivity near a specific frequency point fp (a resonant frequency point) by using the principle that the passive radiator and the housing form strong resonance at the resonant frequency point fp (for example, refer to a patent No. CN1939086A).

However, there are defects with the above two ways. As for the first way, when the size and the volume of the cavity are limited, the effect for enhancing the sensitivity in the low-frequency band is poor by the way of only filling the sound absorbing material. As for the second way, a passive radiator is used, and the passive radiator radiates strongly but the sound generating unit is almost stopped near the resonance frequency point fp, therefore, in frequency bands near fp, the local sensitivity of the acoustic system is enhanced by the high sensitivity design of the passive radiator, but in frequency bands below fp, the phase of the acoustic waves of the passive radiator is opposite to the phase of the acoustic waves of the sound generating unit, and the acoustic waves counteract each other, thus the passive radiator has a negative effect on the sensitivity of the acoustic system. In brief, the passive radiator can only improve the sensitivity in the frequency bands near the resonance point, but cannot improve the sensitivity in all of the low-frequency bands. As shown in FIG. 2, FIG. 2 is test curves (SPL curves) of the loudness at different frequencies for the Prior Art 2 and the Prior Art 1. Therefore, it is necessary to make further improvements for the defects existed in the prior art.

### SUMMARY OF THE INVENTION

An object of the present disclosure is to provide a new cavity structure, and the sound absorbing material is disposed in a closed cavity in combination with the new cavity structure, it is capable of increasing the equivalent volume of the back cavity, reducing the resonance frequency, and significantly improving the sensitivity in the low-frequency bands of the acoustic device as a whole.

To solve the above technical problems, the present disclosure provides the following technical solution: an acoustic device, comprising a sound generating unit which includes a vibrating diaphragm, wherein, the acoustic device is provided with a sound outlet, and acoustic waves at a front side of the vibrating diaphragm is radiated to the outside through the sound outlet;

an enclosed closed cavity is formed at a rear side of the vibrating diaphragm, and at least two volume adjustment regions are provided in the closed cavity, wherein at least one of the volume adjustment regions is a sound absorption portion provided in the closed cavity, and a porous sound absorbing material is provided on the sound absorption portion, and the at least one of the volume adjustment regions is a flexible deformation part;

the closed cavity is divided into a first closed cavity and a second closed cavity by a partition, the first closed cavity is adjacent to the vibrating diaphragm, and the second closed cavity is far away from the vibrating diaphragm, and a volume of the second closed cavity is greater than a volume of the first closed cavity, wherein the flexible deformation part is at least a part of the partition, and the flexible deformation part at least partially deforms flexibly;

when the vibrating diaphragm vibrates, internal sound pressure of the first closed cavity changes, and the flexible deformation part of the partition deforms as the sound pressure in the first closed cavity changes, to flexibly adjust the volume of the first closed cavity, and the second closed cavity encloses the acoustic waves generated by the flexible deformation part during deformation into the second closed cavity;

the sound absorbing material is provided in the first closed cavity and/or the second closed cavity, and the sound absorbing material increases the equivalent volume of the closed cavity; and at least a part of an electronic apparatus housing for mounting the acoustic device is used for forming the first closed cavity and/or the second closed cavity.

Preferably, the porous sound absorbing material is composed of any one or more of activated carbon, zeolite, silica (SiO₂), alumina (Al₂O₃), zirconia (ZrO₂), magnesium oxide (MgO), ferroferric oxide (Fe₃O₄), molecular sieve, spherical shell carbon molecules, carbon nanotubes and sound absorption cotton.

Preferably, entire region or partial region of the flexible deformation part at least uses at least one of TPU, TPEE, LCP, PAR, PC, PA, PPA, PEEK, PEI, PEN, PES, PET, PI, PPS, PPSU, PSU, rubber or silicone.

Preferably, the porous sound absorbing material forms a plurality of porous sound absorption particles by an adhesive.

Preferably, the porous sound absorption particles are isolated from the sound generating unit by an air-permeable isolation member; wherein the air-permeable isolation member is an air-permeable mesh cloth which is fixed on the outside of the sound absorption portion by bonding, hot melting or injection molding; or the air-permeable isolation member includes a frame fixed on the outside of the sound absorption portion by injection molding and an air-permeable mesh cloth coupled with the frame by injection molding; or the air-permeable isolation member is a partition plate fixed on the outside of the sound absorption portion, and a plurality of air-permeable holes are provided on the partition plate.

Preferably, the porous sound absorbing material is formed into a block shape by an adhesive, and is mounted in cavity of the first closed cavity and/or the second closed cavity.

Preferably, the sound absorption portion is provided with one, and is distributed in cavity of the first closed cavity or the second closed cavity; or

the sound absorption portion is provided in plural, and the plurality of sound absorption portions are all distributed in the cavity of the first closed cavity/the second closed cavity; or

the sound absorption portion is provided in plural, wherein a part of the sound absorption portions is distributed in the cavity of the first closed cavity, and the other part of the sound absorption portions is distributed in the cavity of the second closed cavity.

Preferably, a first sound absorption portion and a second sound absorption portion are provided in the cavity of the first closed cavity/the second closed cavity, and the first sound absorption portion and the second sound absorption portion are arranged in parallel and spaced apart with each other, or abut to each other.

Preferably, a first sound absorption portion and a second sound absorption portion are provided in the cavities of the first closed cavity and the second closed cavity respectively, and the first sound absorption portion and the second sound absorption portion are disposed opposite to each other or disposed staggered with each other, or disposed at intervals with a predetermined distance.

Preferably, the types of the porous sound absorbing materials provided in the plurality of the sound absorption portions are different.

Preferably, the sound generating unit and the first closed cavity are provided in plural by one-to-one correspondence relationship, and the second closed cavity is provided with one, and the partition between each of the first closed cavities and the second closed cavity is provided with the flexible deformation part; and

the first sound absorption portion includes a plurality of first sub-sound absorption portions respectively provided in the cavities of the plurality of first closed cavities, and the second sound absorption portion includes a plurality of second sub-sound absorption portions spaced apart and provided in the cavity of the second closed cavity.

Preferably, the sound generating unit is provided with one or more, and the first closed cavity is provided with one, and the second closed cavity is provided with one or more; and

the first sound absorption portion and the second sound absorption portion respectively include a plurality of first sub-sound absorption portions and a plurality of second sub-sound absorption portions spaced apart and provided in the cavities of the first closed cavity and the second closed cavity; or

the first sound absorption portion includes a plurality of first sub-sound absorption portions spaced apart and provided in the cavity of the first closed cavity, and the second sound absorption portion includes a plurality of second sub-sound absorption portions respectively provided in the cavities of the plurality of second closed cavities.

Preferably, the acoustic device includes a first housing, and the sound generating unit is mounted on the first housing to form a sound generating assembly, and the first closed cavity is formed between the vibrating diaphragm of the sound generating unit and the first housing; and

the acoustic device includes a second housing, and the second closed cavity is formed between the second housing and the first housing, and the sound generating assembly is mounted in the second housing.

Preferably, a part of the first housing forms the partition, and the flexible deformation part of the partition is an independent component, and the flexible deformation part and other parts of the first housing are connected and fixed by means of bonding, welding or hot melting; or

the flexible deformation part is integrally coupled with other parts of the first housing;

the second housing is an electronic apparatus housing.

Preferably, the second housing has a top wall, a bottom wall, and a side wall connecting the top wall and the bottom wall, and the sound outlet is provided on the top wall, the bottom wall or the side wall.

Preferably, a vibration direction of the vibrating diaphragm of the sound generating unit is parallel to a thickness direction of the acoustic device; and bodies of the first closed cavity and the second closed cavity extend in a horizontal direction perpendicular to the thickness direction of the acoustic device.

Preferably, the sound generating unit is a miniature sound generating unit.

Another object of the present disclosure is to provide an electronic apparatus comprising the above acoustic device, the sound generating device can effectively reduce the resonance frequency, increase the virtual volume of the rear cavity, and significantly improve the sensitivity in the low-frequency bands of the product as a whole.

In order for solving the above technical problems, the technical solution of the present disclosure is to provide an electronic apparatus comprising the above acoustic device.

Preferably, the electronic apparatus includes an electronic apparatus housing, and at least a part of the electronic apparatus housing of is used to form the first closed cavity and/or the second closed cavity.

Preferably, the acoustic device includes a first housing, and the sound generating unit is mounted on the first housing to form a sound generating assembly, and the first closed cavity is formed between the vibrating diaphragm of the sound generating unit and the first housing; the acoustic device further includes a second housing, and the sound generating assembly is mounted in the second housing, and the second closed cavity is formed between the second housing and the first housing;

a part of the first housing forms the partition; and

the second housing is an electronic apparatus housing.

Compared with the prior art, in the technical solution provided by the present disclosure, firstly, the cavity structure in the prior art is changed. In the acoustic device of the present disclosure, the closed cavity at the rear side of the vibrating diaphragm is divided into a first closed cavity and a second closed cavity by a partition, and a flexible deformation part is provided on the partition. By providing the flexible deformation part, the flexible deformation part deforms with the sound pressure, as one structure of the volume adjustment region, so that the volume of the first closed cavity can be adjusted, thereby increasing the equivalent acoustic compliance of the first closed cavity, effectively reducing the resonance frequency of the acoustic device, and improving the sensitivity in the low-frequency bands. Further, by the isolating configuration for the sound generating unit and the flexible deformation part, the radiated acoustic wave of the flexible deformation part is enclosed inside the acoustic device, so as to avoid the sound waves with anti-phase radiated by the flexible deformation part to counteract the positive sound waves radiated by the sound generating unit, and therefore significantly improving the sensitivity in the low-frequency bands of the product as a whole. Besides, in addition to the above-mentioned flexible deformation part, a sound absorption portion is also provided in the closed cavity and another volume adjustment region is formed, a sound absorbing material is provided in the sound absorption portion, so that can further increase the equivalent volume of the closed cavity and further optimize and promote the acoustic compliance.

Through the following detailed description of exemplary embodiments of the present disclosure with reference to the accompanying drawings, other features and advantages of the present disclosure will become clearly.

### BRIEF DESCRIPTION OF THE DRAWINGS

The drawings, which are incorporated in and constituted a part of the specification, illustrate the embodiments of the present disclosure, illustrate the principle of the present disclosure together with the description thereof.

FIG. 1 is a schematic diagram of the structure of an acoustic device provided with a passive radiator in the prior art.

FIG. 2 illustrates test curves (SPL curves) of the loudness at different frequencies for an acoustic device provided with a passive radiator in the prior art 2 and an acoustic device with a traditional structure in the prior art 1.

FIG. 3 illustrates test curves (SPL curves) of the loudness at different frequencies for an acoustic device according to an embodiment of the present disclosure and an acoustic device with a traditional structure in the prior art 1.

FIG. 4 illustrates test curves (SPL curves) of the loudness at different frequencies for an acoustic device according to an embodiment of the present disclosure and an acoustic device provided with a passive radiator in the prior art 2.

FIG. 5 is a schematic diagram of the structure of an acoustic device according to an embodiment of the present disclosure.

FIG. 6 is a schematic diagram of the structure of an acoustic device according to another embodiment of the present disclosure.

FIG. 7 is schematic diagram of the structure of an acoustic device according to further another embodiment of the present disclosure.

FIG. 8 is a schematic diagram of the structure of an acoustic device according to yet another embodiment of the present disclosure.

FIG. 9 is a schematic diagram of the structure of an acoustic device according to still another embodiment of the present disclosure.

FIG. 10 is a schematic diagram of the structure of an acoustic device according to also another embodiment of the present disclosure.

FIG. 11 is a schematic diagram of an acoustic device according to an embodiment of the present disclosure in operating state.

FIG. 12 illustrates test curves (SPL curves) of the loudness at different frequencies for an acoustic device according to an embodiment of the present disclosure, the prior art 1 and the prior art 2.

FIG. 13 is a schematic diagram of the structure of an acoustic device according to an embodiment of the present disclosure when applied to an electronic apparatus.

FIG. 14 is a partial enlarged diagram of FIG. 13.

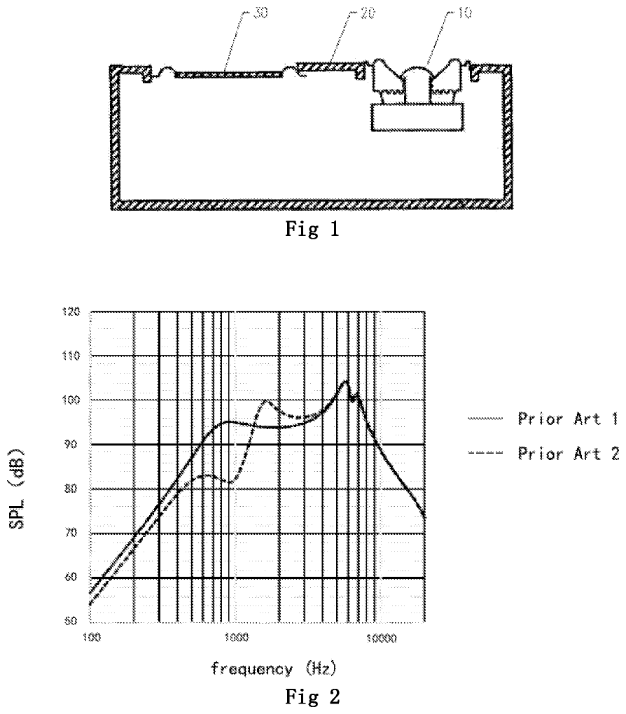

### DESCRIPTION OF REFERENCE NUMERALS

1: sound generating unit; 11: vibrating diaphragm; 2: first housing; 21: first closed cavity; 22: flexible deformation part; 3: second housing; 31: second closed cavity; 4: sound outlet 5: electronic apparatus; 6: sound absorption portion; 61: first sound absorption portion; 611: first sub-sound absorption portion; 62: second sound absorption portion; 621: second sub-sound absorption portion; 7: air-permeable isolation member; 71: porous sound absorption particle; 72: sound absorption cotton.

### DETAILED DESCRIPTION OF THE EMBODIMENTS

Various exemplary embodiments of the present disclosure will be described in detail below with reference to the drawings. It should be noted that the relative position relationships, the numerical expressions and the numerical values of components and steps set forth in these embodiments do not limit the protection scope of the present disclosure unless specifically stated otherwise.

The following description of at least one exemplary embodiment is actually only illustrative, and does serve as any limitation to the present disclosure and the application or the use thereof.

The technologies, methods, and apparatus known by those skilled in the art may not be discussed in detail, but in appropriate situations, the technologies, methods, and apparatus should be regarded as a part of the specification.

In all of the examples illustrated and discussed herein, any specific value should be interpreted as only illustrative, rather than restrictive. Therefore, other examples of the exemplary embodiment may have different values.

It should be noted that similar reference numerals and letters refer to similar items in the drawings, therefore, once one item is defined in one drawing, it does not need to be further discussed in the subsequent drawings.

### Embodiment 1

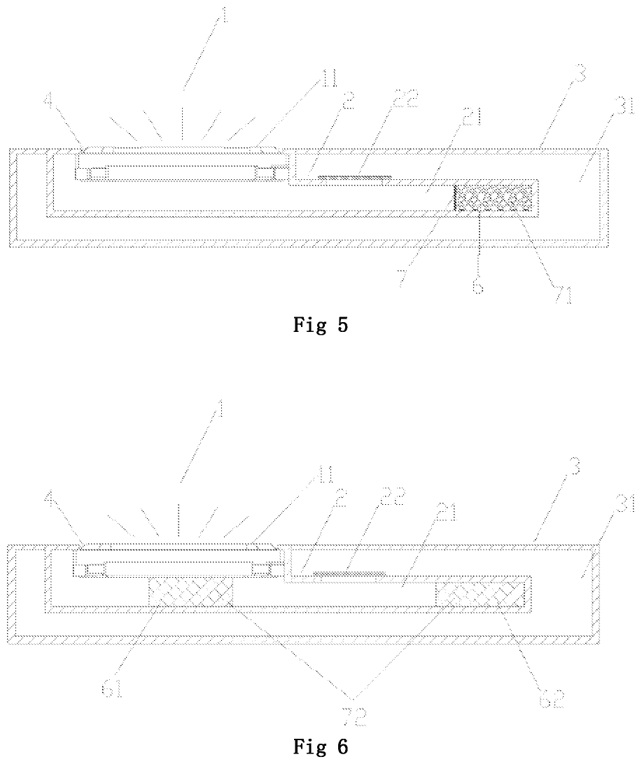

As shown in FIG. 5, an acoustic device includes a sound generating unit 1. In the present embodiment, the sound generating unit 1 is a miniature sound generating unit. More specifically, the sound generating unit 1 is a miniature moving coil speaker. The sound generating unit 1 generally includes a housing and a vibration system and a magnetic circuit system accommodated and fixed in the housing. The vibration system includes a vibration diaphragm 11 fixed on the housing and a voice coil coupled on the vibration diaphragm 11. The magnetic circuit system is provided with a magnetic gap, and the voice coil is disposed in the magnetic gap, and the voice coil reciprocates up and down in the magnetic field after the alternating current is applied to the voice coil, to drive the vibrating diaphragm 11 to vibrate and produce sound.

A sound outlet 4 is provided on the acoustic device, and the acoustic waves at the front side of the vibrating diaphragm 11 is radiated to the outside through the sound outlet 4, and the acoustic waves at the rear side of the vibrating diaphragm 11 is retained inside the acoustic device. A cavity is formed between the vibrating diaphragm 11 and the housing and the magnetic circuit system. Generally, a rear sound hole is provided on the housing or the magnetic circuit system or provided between the housing and the magnetic circuit system. The acoustic waves at the rear side of the vibrating diaphragm 11 may enter into the interior of the acoustic device through the rear sound hole. In this embodiment, the vibration direction of the vibrating diaphragm 11 of the sound generating unit 1 is parallel to a thickness direction of the acoustic device, which is benefit to the thin design of the acoustic device.

Further, in the present embodiment, the rear side of the vibrating diaphragm 11 forms an enclosed closed cavity, and the closed cavity is divided into a first closed cavity and a second closed cavity by a partition. In order to solve the problems in the prior art that the effect of using the sound absorbing material alone to improve the sensitivity in the low-frequency bands is poor and the frequency band can be improved by using a passive radiator structure alone is limited, in the present embodiment, at least two volume adjustment regions are provided in the closed cavity simultaneously, wherein, at least one volume adjustment region is a sound absorption portion provided in the closed cavity, a porous sound absorbing material is provided on the sound absorption portion, and at least one volume adjustment region is a flexible deformation part;

wherein the flexible deformation part is at least a part of the partition, and the flexible deformation part at least partially deforms flexibly. The deformation of the flexible deformation part causes the volume of the first closed cavity to deform according to the change of the sound pressure, so that the first closed cavity is a flexible cavity and the volume thereof is variable. The sound absorbing material is disposed in the first closed cavity and/or the second closed cavity, and the sound absorbing material increases the equivalent volume inside the closed cavity.

Specifically, in the present embodiment, the sound absorption portion 6 is in the cavity of the first closed cavity 21, and the porous sound absorbing material is porous sound absorption particles 71 coupled by an adhesive.

At the time of assembling, in order to avoid the porous sound absorption particles 71 from entering the inside of the sound generating unit, the air-permeable isolation member 7 should be fixed on the outside of the sound absorption portion 6. Specifically, the air-permeable isolation member 7 may be composed by a separate air-permeable mesh cloth, for example, well-known air-permeable mesh materials, such as a metal mesh and a wire mesh cloth. The air-permeable mesh cloth can be fixed on the outside of the sound absorption portion 6 by injection molding or hot melting, for example, fixed to the housing wall of the first housing 2 by heat melting. In addition, the air-permeable isolation member 7 may also be a set of isolation components, including a frame injection-molded on the outside of the sound absorption portion 6, and the air-permeable mesh cloth described above is coupled on the frame by adhesive glue or by integral injection molding. Furthermore, the air-permeable isolation member 7 may also be a rigidity partition plate, on which a plurality of air-permeable holes may be provided. It should be understood that, in order to avoid the porous sound absorbing material from entering the inside of the sound generating unit, the aperture of the air-permeable holes on the partition plate should be smaller than the smallest particle size of the porous sound absorption particles 71.

It should be illustrated that, during the specific implementation, the porous sound absorbing material may also be provided in the cavity of the second closed cavity 31, and the kinds of the porous sound absorbing material can be selected flexibly, for example, it may be consist of any one or more of activated carbon, zeolite, silica (SiO₂), alumina (Al₂O₃), zirconia (ZrO₂), magnesium oxide (MgO), ferroferric oxide (Fe₃O₄), molecular sieve, spherical shell carbon molecules, carbon nanotubes and sound absorption cotton.

In the present embodiment, the partition for dividing the closed cavity can at least partially deform flexibly, and the portion which can at least partially deform flexibly is a flexible deformation part 22, and the first closed cavity 21 is adjacent to the vibrating diaphragm 11, and the second closed cavity 31 is far away from the vibrating diaphragm 11.

Further, in the present embodiment, the volume of the second closed cavity 31 is greater than the volume of the first closed cavity 21.

When the vibrating diaphragm 11 vibrates, the internal sound pressure of the first closed cavity 21 changes, and the flexible deformation part 22 of the partition deforms as the sound pressure in the first closed cavity 21 changes, thus the volume of the first closed cavity 21 is adjusted flexibly, and the second closed cavity 31 encloses the acoustic waves generated by the flexible deformation part 22 during deformation into the second closed cavity 31.

In the present embodiment, at least a part of an electronic apparatus housing for mounting the acoustic device is used for forming the first closed cavity 21 and/or the second closed cavity 31. Wherein, the electronic apparatus 5 may be a mobile phone, a tablet computer, a notebook computer and the like. That is, part or all of the cavity wall of the first closed cavity 21 is formed by the electronic apparatus housing, or part or all of the cavity wall of the second closed cavity 31 is formed by the electronic apparatus housing, or part or all of the cavity walls of the first closed cavity 21 and the second closed cavity 31 are formed by the electronic apparatus housing. In the present disclosure, the electronic apparatus housing is also used as the cavity wall of the first closed cavity and/or the second closed cavity, thus the space inside the electronic apparatus can be fully utilized, and in the meanwhile, the space occupied by a part of the cavity wall might be saved, which is more benefit to the thin design of the electronic apparatus.

It should be noted that the “closed” described in the present embodiment and the present disclosure may be a fully closed state or a relatively closed state in a physical structure. For example, the first closed cavity may include a pressure equalizing hole 23 which provided to balance the internal and external air pressures and does not have significant influence on the rapid change of the sound pressure based on the product usage requirements, or other hole structures, and is also regarded as a closed cavity. Further, for example, the second closed cavity may include a gap generated when the second closed cavity is combined with the first closed cavity, and the like, as well as a gap in its own structure, and the like, which can effectively isolate the acoustic waves generated by the flexible deformation part, and does not have significant influence on the acoustic waves generated by the sound generating unit, and is also regarded as a closed cavity. In general, the total areas of the above-mentioned holes or gaps do not exceed 20 mm².

As a specific embodiment, the acoustic device includes a first housing 2, the sound generating unit 1 is mounted on the first housing 2 to form a sound generating assembly, and a first closed cavity 21 is formed between the vibration diaphragm 11 of the sound generating unit 1 and the first housing 2; the acoustic device includes a second housing 3, and the sound generating assembly is mounted in the second housing 3, and a second closed cavity 31 is formed between the second housing 3 and the first housing 1; a part of the first housing 2 forms the partition. Wherein, in the case where there are other components in the second housing 3, the second closed cavity 31 is actually formed by the gap between the components and the second housing 3, the first housing 2.

In the present embodiment, the sound generating unit 1 is provided inside the first housing 2, and the sound generating unit 1 and the first housing 2 form an integral structure, and then the integral structure is assembled with the second housing 3. The first housing 2 is provided with an opening, and a space at the front side of the diaphragm communicates with the opening, and the sound is radiated to the sound outlet 4 of the acoustic device through the opening.

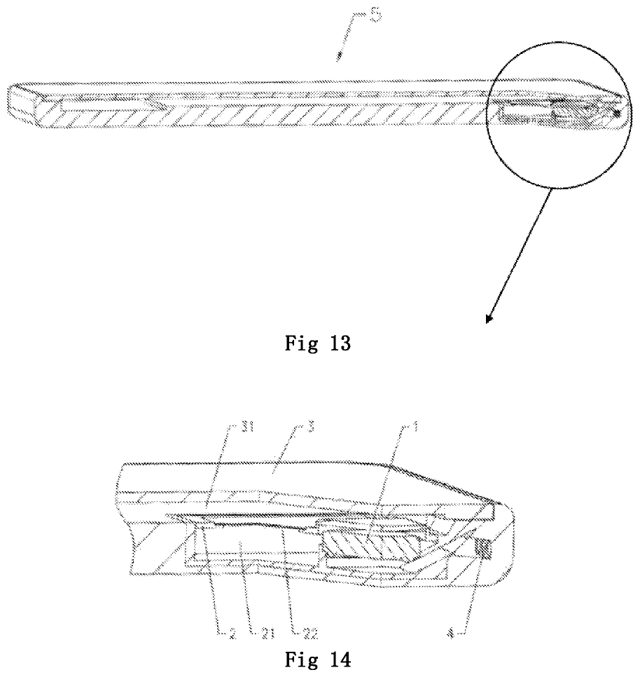

In the present embodiment, as shown in the structural diagrams of the electronic apparatus of FIGS. 13 and 14, the acoustic device is mounted in an electronic apparatus such as a mobile phone, and the electronic apparatus housing is also used as the second housing 3 of the acoustic device. The space between the electronic apparatus housing and the internal components and the space between the electronic apparatus housing and the first housing 2 of the acoustic device form the second closed cavity 31, and the second housing of the acoustic device itself is omitted. Therefore, the gap space between the housing and the components of the electronic apparatus are fully utilized, and the volume of second closed cavity 31 can be maximized.

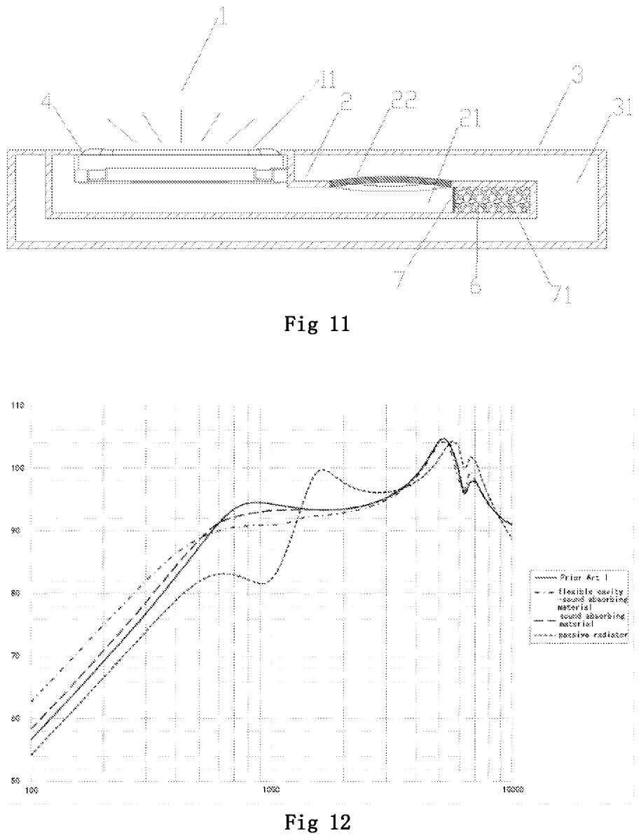

As shown in FIG. 11, in the operating state of the acoustic device, when the vibrating diaphragm 11 vibrates downwards to compress the volume at the rear side of the vibrating diaphragm 11, the sound pressure will be transmitted to the flexible deformation part 22 through the first closed cavity 21, and the flexible deformation part 22 expands and deforms toward the outside of the first closed cavity 21; on the contrary, when the diaphragm vibrates upward, the flexible deformation part 22 will retract and deform inwardly, to adjust the volume of the first closed cavity 21. Wherein, the body of the flexible deformation part 22 might be a plastic material or a thermoplastic elastomer material, or a silicone rubber material. Further, the body of the flexible deformation part 22 might be a one-layer structure or a multi-layer composite structure. Further, the body of the flexible deformation part may be a flat plate-shaped structure, or a partially convex or concave structure, such as a structure with a convex central part, a convex edge part, or a combination of a convex central part and a convex edge part. Specifically, entire region or partial region of the flexible deformation part 22 at least use at least one of TPU, TPEE, LCP, PAR, PC, PA, PPA, PEEK, PEI, PEN, PES, PET, PI, PPS, PPSU and PSU. In addition, the thickness of the flexible deformation part is less than or equal to 0.5 mm, since if the thickness is too thick, the strength of the flexible deformation part increases and the compliance decreases, which is not benefit to deformation.

Further, in order for improving the vibration effect, a composite sheet may be overlapped on a middle part of the body of the flexible deformation part 22. The strength of the composite sheet is higher than the strength of the body, and the composite sheet may be metal, plastic, carbon fiber, or a composite structure thereof, and the like. In addition, the body of the flexible deformation part 22 may be a sheet shaped overall structure, or a structure in which the middle is hollow out and a composite sheet is overlapped thereon. In the case where the body of the flexible deformation part 22 is hollow out in the middle and retains only the edge part, the edge part may be a flat shape, a shape protruding to one side, or a wave shape.

In the present embodiment, preferably, the flexible deformation part 22 is integrated with other parts of the first housing 2. As a specific solution, firstly, the flexible deformation part 22 may be manufactured, and then the flexible deformation part 22 may be integrally molded into the other parts of the housing as an insert member.

In the present embodiment, the bodies of the first closed cavity 21 and the second closed cavity 31 extend along a horizontal direction formed by a length and a width of the acoustic device, the horizontal direction may also be defined by a direction perpendicular to a thickness direction of the acoustic device. The horizontal direction generally refers to a direction parallel to a horizontal plane when the acoustic device is placed on a horizontal plane, and the two cavities are provided along the horizontal direction, so as to not occupy the space in the height direction of the acoustic device as much as possible, which is benefit to the thin design of the product.

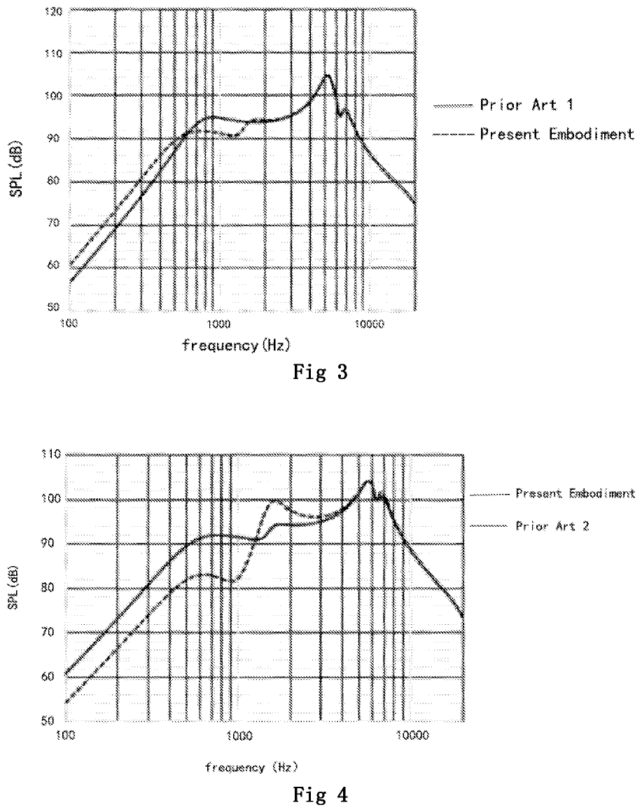

The second housing 3 has a top wall, a bottom wall, and a side wall connecting the top wall and the bottom wall, and the sound outlet 4 of the acoustic device is provided on the top wall, the bottom wall or the side wall. As shown in FIG. 3 and FIG. 4, in the present embodiment, the sound outlet 4 is provided on the top wall, and a pressure equalizing hole is provided on the first closed cavity 21.

In the technical solution of the present embodiment, in the acoustic device, the closed cavity at the rear side of the vibrating diaphragm 11 is divided into a first closed cavity 21 and a second closed cavity 31 by a partition, and a flexible deformation part 22 is provided on the partition. By providing the flexible deformation part 22, the flexible deformation part 22 deforms with the sound pressure, and the volume of the first closed cavity 21 is adjustable, thereby increasing the equivalent acoustic compliance of the first closed cavity 21, effectively reducing the resonance frequency of the acoustic device, and improving low-frequency sensitivity. By means of the second closed cavity 31, the sound radiation generated during the deformation of the flexible deformation part 22 is isolated, and the radiated acoustic waves of the flexible deformation part 22 are enclosed inside the acoustic device, so as to avoid the sound waves with anti-phase radiated by the flexible deformation part to counteract the positive sound waves radiated by the sound generating unit 1, and therefor significantly improving the sensitivity in the low-frequency bands of the product as a whole.

In addition, in the present embodiment, the volume of the second closed cavity 31 is greater than the volume of the first closed cavity 21, so as to make the deformation of the flexible deformation part 22 more easier, more benefit to increase the equivalent acoustic compliance of the first closed cavity 21, effectively reduce the resonant frequency of the acoustic device, and improve the low frequency sensitivity.

In the prior art 1, the compliance of the acoustic device is configured by the compliance parallel connection of the sound generating unit and the closed cavity in the housing. The ‘fs’ formula of the prior art 1 is as follows:

$${f}_{s} = \frac{1}{2 * π} \sqrt{\frac{{C}_{a s} + {C}_{a b}}{{C}_{a s} * {C}_{a b} * {M}_{a c}}}$$

Wherein, fs: the resonance frequency of the acoustic device; Cas: the equivalent acoustic compliance of the sound generating unit; Cab: the equivalent acoustic compliance of the air in the first closed cavity; Mac: the equivalent sound quality of the vibration system of the sound generating unit.

In the prior art 1 and the present embodiment, as shown in FIG. 2 and FIG. 3, FIG. 2 is test curves (SPL curves) of the loudness at different frequencies for an acoustic device provided with a passive radiator in the prior art 2 and an acoustic device with a traditional structure in the prior art 1. FIG. 3 is test curves (SPL curves) of the loudness at different frequencies for an acoustic device according to the present embodiment and an acoustic device of the prior art 1. As the sound generating unit is in compliance parallel connection further with a passive radiator/flexible deformation part 22, therefore the finally equivalent compliance increases, thereby FO is reduced.

The ‘fs’ formula of the prior art 2 and the present embodiment is as follows:

$${f}_{s} = \frac{1}{2 * π} \sqrt{\frac{{C}_{a s} + {C}_{a b} + {C}_{ap}}{{C}_{a s} * {C}_{a b} * {C}_{ap} * {M}_{a c}}}$$

Wherein, fs: the resonance frequency of the acoustic device; Cas: the equivalent acoustic compliance of the sound generating unit; Cab: the equivalent acoustic compliance of the air in the first closed cavity; Mac: the equivalent sound quality of the vibration system of the sound generating unit; Cap: the equivalent acoustic compliance of the passive radiator/flexible deformation part.

Moreover, in the prior art 2, the sound generating unit and the passive radiator radiate to the outside simultaneously. The phases of the acoustic waves of the sound generating unit and the passive radiator have opposite phases at frequencies below the resonance point ‘fp’, thus the sound pressure counteracts with each other, and the passive radiator has a negative effect on the sensitivity of the acoustic system.

Further, in the present embodiment, as shown in FIG. 4, FIG. 4 is test curves (SPL curves) of the loudness at different frequencies for an acoustic device according to the present embodiment and an acoustic device provided with a passive radiator in the prior art 2. By providing the enclosed second closed cavity 31, the second closed cavity 31 causes the acoustic waves generated at the rear side of the diaphragm of the acoustic device to remain inside the acoustic device. Specifically, by means of the second closed cavity 31, the sound pressure generated by the flexible deformation part 22 is isolated, so as to avoid the sound waves with anti-phase radiated by the flexible deformation part 22 to counteract the positive sound waves radiated by the sound generating unit, therefore significantly improving the sensitivity in the low-frequency bands of the product as a whole.

In addition, as shown in FIG. 12, FIG. 12 is test curves (SPL curves) of the loudness at different frequencies for the three structures of adding sound absorbing material, adding passive radiator, and adding sound absorbing material to the flexible cavity in the acoustic device in comparison with the prior art 1. It is obviously from the comparison curves that when there is only sound absorbing material, the improvement effect to the sensitivity in the low-frequency bands is poor. Further, in the case where the volume and size of the acoustic device are very limited, the sensitivity in the low-frequency bands of the acoustic device is not obviously improved by adding the sound absorbing material alone. When adding the passive radiator alone, the improved range of frequency bands is relatively limited, that is, in the frequency bands near ‘fp’, the local sensitivity of the acoustic system is enhanced; but in the frequency bands below ‘fp’, the acoustic waves of the passive radiator and the sound generating unit have opposite phases, therefore the acoustic waves counteract with each other, and the passive radiator has a negative effect on the sensitivity of the acoustic system. However, in the embodiment, when both of the two expansion regions are provided and the anti-phase acoustic waves generated by the flexible deformation part are enclosed and isolated, the effect of improving the sensitivity in the low-frequency band is optimal.

### Embodiment 2

As shown in FIG. 6, the main difference between this embodiment and the embodiment 1 is that there are two sound absorption portions 6 in this embodiment, that is, a first sound absorption portion 61 and a second sound absorption portion 62, which are arranged in parallel and spaced apart. In addition, the porous sound absorbing material is formed into a block shape by an adhesive, and is mounted in the cavity of the first closed cavity and/or the second closed cavity, and specifically, a sound absorption cotton 72 is used. The sound absorption cotton 72 is fixed to the two sound absorption portions by adhesive glue, the region defined by the volume of the sound absorption cotton 72 is the region where the two sound absorption portions are located. In the structure as shown in FIG. 6, one of the sound absorption cottons 72 is attached to the bottom of the sound generating unit 1, and the other sound absorption cotton 72 is far away from the sound generating unit 1 and is positioned at the edge of the first closed cavity 21. However, during actual implementation, the specific arrangement of multiple pieces of the sound absorption cottons is not limited, in addition to arranged in parallel and spaced apart, they may also adjacent to each other.

As a further improvement of the present embodiment, the two sound absorption portions may also be provided in the cavity of the second closed cavity 31, which can also achieve the technical effects of the present disclosure.

### Embodiment 3

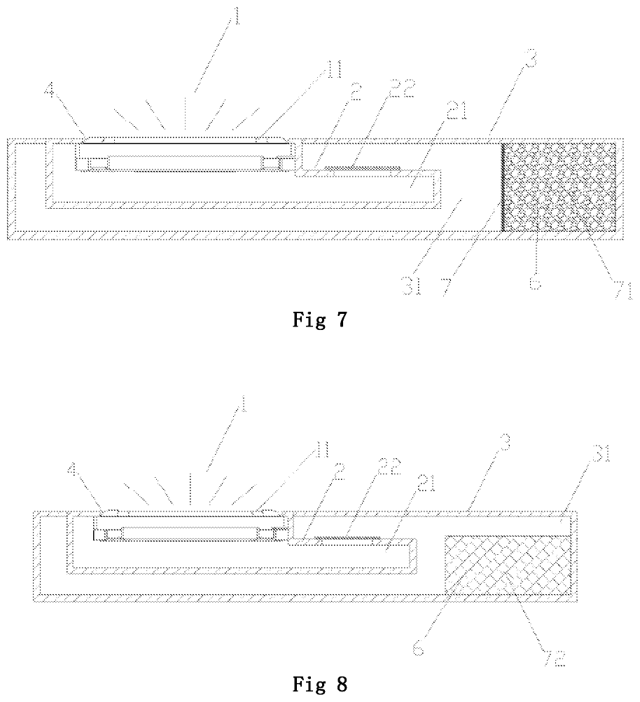

As shown in FIG. 7, the main difference between this embodiment and embodiment 1 is that the sound absorption portion 6 is specifically located in the cavity of the second closed cavity 31, and the porous sound absorption particles 71 are also provided inside the cavity of the second closed cavity 31 correspondingly in this embodiment. During implementation, since the volume of the second closed cavity 31 is preferably larger than the volume of the first closed cavity 21, therefore, by the way of disposing the porous sound absorbing material in the cavity of the second closed cavity 31, more particles can be filled, a better sound absorption effect is achieved, and sensitivity in the low-frequency band may be significantly improved.

### Embodiment 4

As shown in FIG. 8, the main difference between this embodiment and the above embodiment is that the porous sound absorbing material provided in the cavity of the second closed cavity 31 is a sound absorption cotton 72 in this embodiment. Since the sound absorption cotton 72 may be directly coupled and fixed to the housing wall of the second housing 3 by an adhesive glue, and the sound absorption cotton 72 itself may be easily formed into different sizes, volumes and shapes by manner of cutting and the like, therefore the sound absorption cotton 72 is more easily assembled to the second closed cavity.

### Embodiment 5

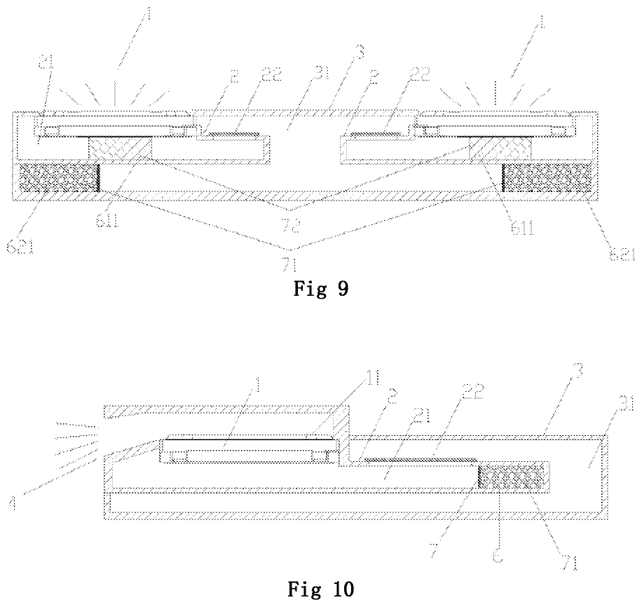

The main difference between this embodiment and the above embodiment is that, in this embodiment, there are a plurality of sound generating units 1 and a plurality of first closed cavities 21 which are corresponding to each other, and there is one second closed cavity 31, and a flexible deformation part is provided on the partition between each of the first closed cavities 21 and the common one second closed cavity 31. Specifically, as shown in FIG. 9, the acoustic device includes two sound generating units 1, and two first closed cavities 21 are provided correspondingly, and there is one second closed cavity 22, and a partition is provided between each of the two first closed cavities 21 and the second closed cavity respectively, and flexible deformation parts 22 are respectively provided on the partitions. This configuration can facilitate to realize the applications when the acoustic device or the acoustic system requires a plurality of sound emitting units 1, such as stereo or array design requirements. In this embodiment, the first closed cavities may also provide with other numbers and form a closed cavity together with the one second closed cavity.

In this structure, the first sound absorption portion 61 includes two first sub-sound absorption portions 611 respectively provided in the cavities of the two first closed cavities 21, and the second sound absorption portion 62 includes two sub-sound absorption portions 621 which are spaced apart and provided in the cavity of the second closed cavity 31. For the four sub-sound absorption portions of the first sound absorption portion 61 and the second sound absorption portion 62, two of them may be disposed opposite to each other or disposed staggered with each other, or disposed at intervals with a predetermined distance. In the drawing, staggered distribution is illustrated.

In addition, as a plurality of sub-sound absorption portions are provided in this embodiment, obviously, there are more possibilities in the choice of the type of the sound absorbing material. For example, different types may be combined to improve the sensitivity in the low-frequency bands. More specifically, the sound absorption cottons 72 are provided in the two first sub-sound absorption portions 61, the sound absorption cotton 72 may be directly attached to the bottom of the sound generating unit 1, and the porous sound absorption particles 71 are disposed in the two second sub-sound absorption portions 62. The sound absorption cotton is easy to be formed and assembled, and the porous sound absorption particles 71 have a better adsorption performance.

As a further improvement of this embodiment, there are a plurality of sound emitting units 1, and the plurality of sound emitting units correspond to the same one first closed cavity 21. Specifically, in this embodiment, there are two sound emitting units 1, and there is one second closed cavity 31, and a flexible deformation part 22 is provided between the first closed cavity 21 and the second closed cavity 31. At this time, the first sound absorption portion 61 and the second sound absorption portion 62 may respectively include a plurality of first sub-sound absorption portions 611 and a plurality of second sub-sound absorption portions 621 spaced apart and provided in the cavities of the first closed cavity 21 and the second closed cavity. This implementation may also be further improved, for example, there may be a plurality of second closed cavities 31, and there is one first closed cavity 21. At this time, the first sound absorption portion 61 may include a plurality of first sub-sound absorption portions 611 spaced apart and provided in the cavity of the first closed cavity 21, and the second sound absorption portion 62 may include a plurality of second sub-sound absorption portions 621 respectively provided in the cavities of a plurality of the second closed cavity 31. All of the above-mentioned different deformations can achieve the technical effect of the present disclosure.

### Embodiment 6

As shown in FIG. 10, the main difference between this embodiment and the above-mentioned embodiment is that, in this embodiment, the acoustic device is provided with a sound channel, and the sound channel is disposed in correspondence with the sound outlet 4, and the acoustic wave at the front side of the vibrating diaphragm 11 radiates to the sound outlet 4 through the sound channel. This configuration is more comply with the design requirements of some terminal products, and does not occupy the space of the panels of the mobile phone and the like, so that it is benefit to the design of full screens, and in the meanwhile it avoids obstruction and interference from other components.

Specifically, as shown in FIG. 10, the sound generating unit 1 is mounted in the first housing 2, and the sound channel is also provided on the first housing 2. In other embodiments, it is also possible that the sound channel is provided on the second housing 3, and the sound generating assembly is opposed to and coupled with the sound channel; or the sound channel is provided separately, and the sound channel is opposed to and coupled with the sound outlet 4 and the sound generating assembly respectively.

In this embodiment, the sound absorption portion 6 is located in the cavity of the first closed cavity 21 and is filled with porous sound absorption particles 71.

In summary, in this technical solution, as long as at least two volume adjustment regions are provided in the cavity of the closed cavity, and at least one of which is a sound absorption portion 6, and a sound absorbing material is provided in the sound absorption portion 6, and at least the other of which is a flexible deformation part 22, a better sensitivity in the low-frequency bands can be achieved. The specific position, number, and arrangement (when in plural) and the like of the sound absorption portion 6 are not intended to limit the technical solution. In addition, the porous sound absorbing material may completely fill the cavity of the closed cavity, or it may partially fill the cavity of the closed cavity as illustrated in the above-mentioned embodiment, which may be flexibly selected according to actual needs.

In addition, the present disclosure also discloses an electronic apparatus, as shown in FIG. 13 and FIG. 14, an acoustic device is mounted in the electronic apparatus, and the electronic apparatus 5 may be a mobile phone, a tablet computer, a notebook, or the like.

The electronic apparatus 5 specifically includes an electronic apparatus housing, and at least a part of the electronic apparatus housing is used for forming the first closed cavity 21 and/or the second closed cavity 31 of the acoustic device. That is, a part or all of the cavity wall of the first closed cavity 21 is formed by the electronic apparatus housing, or a part or all of the cavity wall of the second closed cavity 31 is formed by the electronic apparatus housing, or a part or all of the cavity walls of the first closed cavity 21 and the second closed cavity 31 are formed by the electronic apparatus housing. In the present disclosure, the electronic apparatus housing is also used as the cavity wall of the first closed cavity 21 and/or the second closed cavity 31, so that can fully utilize the space inside the electronic apparatus and in the meanwhile save the space occupied by a part of the cavity wall, which is more benefit to the thin design of the electronic apparatus.

In this specific embodiment, the acoustic device includes a first housing 2, the sound generating unit 1 is mounted on the first housing 2 to form a sound generating assembly, and the first closed cavity 21 is formed between the vibrating diaphragm 11 of the sound generating unit 1 and the first housings 2, wherein the partition is a part of the first housing 2, and the partition is provided with a flexible deformation part 22 thereon. The acoustic device also includes a second housing 3, and the sound generating assembly is mounted in the second housing 3, and the second closed cavity 31 is formed between the second housing 3 and the first housing 1. Wherein, the second housing 3 is an electronic apparatus housing. Actually, the space between the electronic apparatus housing and the internal components and the space between the electronic apparatus housing and the first housing 2 of the acoustic device form a second closed cavity 31, and the electronic apparatus housing is also used as the second housing 3 of the acoustic device, and the second housing of the acoustic device itself is omitted. Therefore, the gap space between the housing and the components of the electronic apparatus are fully utilized, and the volume of second closed cavity 31 can be maximized, which is benefit to the thin design of the electronic apparatus.

Based on the above, although some specific embodiments of the present disclosure have been described in detail by examples, those skilled in the art should understand that the above examples are only for illustration and not for limiting the scope of the present disclosure. Those skilled in the art should understand that the above embodiments may be modified without departing from the scope and spirit of the present disclosure. The scope of the invention is defined by the appended claims.

What is claimed is:

1. An acoustic device, comprising:
a sound generating unit which includes a vibrating diaphragm, wherein a sound outlet is provided on the acoustic device, and acoustic waves at a front side of the vibrating diaphragm is radiated to outside through the sound outlet;
an enclosed closed cavity is formed at a rear side of the vibrating diaphragm, and at least two volume adjustment regions are provided in the closed cavity, wherein at least one of the volume adjustment regions is a sound absorption portion provided in the closed cavity, and a porous sound absorbing material is provided on the sound absorption portion, and the at least one of the volume adjustment regions is a flexible deformation part;
the closed cavity is divided into a first closed cavity and a second closed cavity by a partition, the first closed cavity is adjacent to the vibrating diaphragm, and the second closed cavity is far away from the vibrating diaphragm, and a volume of the second closed cavity is greater than a volume of the first closed cavity, wherein the flexible deformation part is at least a part of the partition, and the flexible deformation part at least partially deforms flexibly;
when the vibrating diaphragm vibrates, internal sound pressure of the first closed cavity changes, and the flexible deformation part of the partition deforms as the sound pressure in the first closed cavity changes, to flexibly adjust the volume of the first closed cavity, and the second closed cavity encloses the acoustic waves generated by the flexible deformation part during deformation into the second closed cavity;
the sound absorbing material is provided in the first closed cavity and/or the second closed cavity, and the sound absorbing material increases the equivalent volume of the closed cavity; and
at least a part of an electronic apparatus housing for mounting the acoustic device is used for forming the first closed cavity and/or the second closed cavity.

2. The acoustic device according to claim 1, wherein:
the porous sound absorbing material is composed of any one or more of activated carbon, zeolite, silica (SiO₂), alumina (Al₂O₃), zirconia (ZrO₂), magnesium oxide (MgO), ferroferric oxide (Fe₃O₄), molecular sieve, spherical shell carbon molecules, carbon nanotubes and sound absorption cotton.

3. The acoustic device according to claim 1, wherein entire region or partial region of the flexible deformation part at least uses at least one of TPU, TPEE, LCP, PAR, PC, PA, PPA, PEEK, PEI, PEN, PES, PET, PI, PPS, PPSU, PSU, rubber or silicone.

4. The acoustic device according to any one of claims 1 to 3, wherein the porous sound absorbing material forms a plurality of porous sound absorption particles by an adhesive.

5. The acoustic device according to claim 4, wherein:
the porous sound absorption particles are isolated from the sound generating unit by an air-permeable isolation member; wherein
the air-permeable isolation member is an air-permeable mesh cloth which is fixed on the outside of the sound absorption portion by bonding, hot melting or injection molding; or the air-permeable isolation member includes a frame fixed on the outside of the sound absorption portion by injection molding and an air-permeable mesh cloth coupled with the frame by injection molding or the air-permeable isolation member is a partition plate fixed on the outside of the sound absorption portion, and a plurality of air-permeable holes are provided on the partition plate.

6. The acoustic device according to claim 2, wherein:
the porous sound absorbing material is formed into a block shape by an adhesive, and is mounted in cavity of the first closed cavity and/or the second closed cavity.

7. The acoustic device according to claim 1, wherein:
the sound absorption portion is provided with one, and is distributed in cavity of the first closed cavity or the second closed cavity; or
the sound absorption portion is provided in plural, and the plurality of sound absorption portions are all distributed in the cavity of the first closed cavity/the second closed cavity; or
the sound absorption portion is provided in plural, wherein a part of the sound absorption portions is distributed in the cavity of the first closed cavity, and the other part of the sound absorption portions is distributed in the cavity of the second closed cavity.

8. The acoustic device according to claim 7, wherein:
a first sound absorption portion and a second sound absorption portion are provided in the cavity of the first closed cavity/the second closed cavity, and the first sound absorption portion and the second sound absorption portion are arranged in parallel and spaced apart with each other, or abut to each other.

9. The acoustic device according to claim 7, wherein:
a first sound absorption portion and a second sound absorption portion are provided in the cavities of the first closed cavity and the second closed cavity respectively, and the first sound absorption portion and the second sound absorption portion are disposed opposite to each other or disposed staggered with each other, or disposed at intervals with a predetermined distance.

10. The acoustic device according to any one of claims 7 to 9, wherein:
the types of the porous sound absorbing materials provided in the plurality of the sound absorption portions are different.

11. The acoustic device according to claim 7, wherein:
the sound generating unit and the first closed cavity are provided in plural by one-to-one correspondence relationship, and the second closed cavity is provided with one, and the partition between each of the first closed cavities and the second closed cavity is provided with the flexible deformation part; and
the first sound absorption portion includes a plurality of first sub-sound absorption portions provided in the cavities of the first closed cavities respectively, and the second sound absorption portion includes a plurality of second sub-sound absorption portions spaced apart and provided in the cavity of the second closed cavity.

12. The acoustic device according to claim 7, wherein:
the sound generating unit is provided with one or more, and the first closed cavity is provided with one, and the second closed cavity is provided with one or more; and
the first sound absorption portion and the second sound absorption portion include a plurality of first sub-sound absorption portions and a plurality of second sub-sound absorption portions spaced apart and provided in the cavities of the first closed cavity and the second closed cavity, respectively; or
the first sound absorption portion includes a plurality of first sub-sound absorption portions spaced apart and provided in the cavity of the first closed cavity, and the second sound absorption portion includes a plurality of second sub-sound absorption portions provided in the cavities of the plurality of second closed cavities respectively.

13. The acoustic device according to claim 1, wherein:
the acoustic device includes a first housing, the sound generating unit is mounted on the first housing to form a sound generating assembly, and the first closed cavity is formed between the vibrating diaphragm of the sound generating unit and the first housing; and
the acoustic device includes a second housing, and the second closed cavity is formed between the second housing and the first housing, and the sound generating assembly is mounted in the second housing.

14. The acoustic device according to claim 13, wherein:
a part of the first housing forms the partition, the flexible deformation part of the partition is an independent component, and the flexible deformation part and other parts of the first housing are connected and fixed by means of bonding, welding or hot melting; or
the flexible deformation part is integrally coupled with other parts of the first housing;
the second housing is an electronic apparatus housing.

15. The acoustic device according to claim 13, wherein, the second housing has a top wall, a bottom wall, and a side wall connecting the top wall and the bottom wall, and the sound outlet is provided on the top wall, the bottom wall or the side wall.

16. The acoustic device according to claim 1, wherein:
a vibration direction of the vibrating diaphragm of the sound generating unit is parallel to a thickness direction of the acoustic device; and
bodies of the first closed cavity and the second closed cavity extend in a horizontal direction perpendicular to the thickness direction of the acoustic device.

17. The acoustic device according to claim 1, wherein:
the sound generating unit is a miniature sound generating unit.

18. An electronic apparatus includes the acoustic device according to any one of claims 1 to 17.

19. The electronic apparatus according to claim 18, comprising an electronic apparatus housing, and at least a part of the electronic apparatus housing is used for forming the first closed cavity and/or the second closed cavity.

20. The electronic apparatus according to claim 19, wherein:
the acoustic device includes a first housing, and the sound generating unit is mounted on the first housing to form a sound generating assembly, and the first closed cavity is formed between the vibrating diaphragm of the sound generating unit and the first housing;
the acoustic device further includes a second housing, and the sound generating assembly is mounted in the second housing, and the second closed cavity is formed between the second housing and the first housing;
a part of the first housing forms the partition; and
the second housing is the electronic apparatus housing.
